(19) United States
(12) Patent Application Publication
(10) Pub. No.: US 2024/0430738 A1
(43) Pub. Date: Dec. 26, 2024

(54) NETWORK NODE, AND METHOD PERFORMED IN A WIRELESS COMMUNICATIONS NETWORK

(71) Applicant: Telefonaktiebolaget LM Ericsson (publ), Stockholm (SE)

(72) Inventors: Lackis ELEFTHERIADIS, Valbo (SE); Athanasios KARAPANTELAKIS, Solna (SE); Maxim TESLENKO, Sollentuna (SE); Aneta VULGARAKIS FELJAN, Stockholm (SE); Marin ORLIC, Bromma (SE)

(21) Appl. No.: 18/692,548

(22) PCT Filed: Sep. 17, 2021
(86) PCT No.: PCT/SE2021/050894

§ 371 Date: Mar. 15, 2024

(51) Int. Cl. H04W 28/02; H04L 41/16; H04W 28/08

(52) U.S. Cl. CPC H04W 28/0268; H04L 41/16; H04W 28/0221; H04W 28/0917

(57) ABSTRACT

Embodiments herein disclose, e.g., a method performed by a network node, in a wireless communications network, for charging a rechargeable power source in the network node. The network node obtains an operational parameter to an operation of the network node, wherein the operational parameter is based on an output of a computational model. The computational model is based on a state of charge of the rechargeable power source, a parameter related to outage of a power grid, and a QoS parameter relating to radio communication in the wireless communications network. The network node further applies, during a charging of the rechargeable power source, the operational parameter to the operation of the network node.

### TECHNICAL FIELD

Embodiments herein relate to a network node and method performed therein regarding operation of the network node. Furthermore, a computer program product and a computer-readable storage medium are also provided herein. Especially, embodiments herein relate to handling operation, such as handling charging of a rechargeable power source of the network node in a wireless communications network.

### BACKGROUND

In a typical wireless communications network, user equipments (UE), also known as wireless communication devices, mobile stations, stations (STA) and/or wireless devices, communicate e.g. via a Radio access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node. The radio network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases, such as 4G and 5G networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Beamforming allows the signal to be stronger for an individual connection. On the transmit-side this may be achieved by a concentration of the transmitted power in the desired direction(s), and on the receive-side this may be achieved by an increased receiver sensitivity in the desired direction(s). This beamforming enhances throughput and coverage of the connection. It also allows reducing the interference from unwanted signals, thereby enabling several simultaneous transmissions over multiple individual connections using the same resources in the time-frequency grid, so-called multi-user Multiple Input Multiple Output (MIMO).

Batteries such as Valve Regulated Lead Acid (VRLA) batteries, Lithium-ion batteries, or other energy storing batteries, are used today as battery back-up for network nodes, for e.g. radio network nodes in GSM, WCDMA and LTE. During a power outage on a radio base station (RBS) site, it is important to recharge the batteries as fast as possible. This is especially important when multiple consecutive power outages of the power grid occur for example in third world countries. Current RBS solution has only one extra Power Supply Unit (PSU) to support battery recharging and it is also used as a redundant power supply, in case of PSU fail. When power from the power grid is available again, the recharging time of the batteries depends heavily on the radio load conditions of the RBS, as the power supply is divided to feed power between the radio loads and battery recharge, see FIG. 1. FIG. 1 shows the existing architecture without any fast charging, when power outage occurs. Estimated power needed for the 9 radio units, are power from 5 PSUs, including battery charging. BB is short for Baseband, PDU for Power Distribution Unit, BFU for Battery Fuse Unit and PSU for Power Supply Unit.

Current and existing technologies or methods for fast charging of batteries on an RBS site are:
1) adding more PSUs to the RBS to enable fast charging of batteries and to allow the power of the extra added PSU to charge the batteries when the grid is back, see FIG. 2. In FIG. 2 it can be seen the architecture with added PSU for fast charging, when power outage occurs. In a typical configuration when the number of power outages are 5-10 per day, at least 3 more PSUs are needed to fully charge the batteries, before a next outage cycle.
2) increase the power availability by using a diesel generator (DG) in extensive power outages to supply both power to the radio load and to charge the batteries. If power is available from the grid, batteries are charged from both power sources. These current solutions are neither efficient nor environmentally friendly. Rather, they only increase the total cost of the infrastructure, since both DG and PSU add additional costs.

### SUMMARY

In areas where consecutive power outages are commonplace, the batteries are not able to be fully charged. For example, operators in some countries may suffer 8-15 outages per day, and/or suffer outages of different durations per day. When batteries are not fully charged the batteries' lifetime degrades and, above all, when the batteries are not fully charged, the batteries are not able to support a next incoming power outage during the same day. Power outages vary in time (it is not constant), and the outage duration is heavily impacted on the operation and the charging of the batteries. RBS only charges batteries during that short time when power from the grid is available if the power grid is the only source of power.

The current solution of adding multiple or several PSUs to charge the batteries during the short time when the grid returns, will fully charge the batteries. However, it is not so cost efficient, and requires extra space in cabinets such as an RBS cabinet. Also, another disadvantage by adding several PSU, is that there is a need to increase the fuse rating of the incoming alternating current (AC) grid, which increases the cost.

Similar disadvantages exist if an extra DG is added to support powering and charging the batteries.

An object of embodiments herein is to provide a mechanism that efficiently improves operations of a network node in a wireless communications network.

According to an aspect the object is achieved by providing a method performed by a network node, in a wireless communications network, for charging a rechargeable power source in the network node. The network node obtains an operational parameter to an operation of the network node, wherein the operational parameter is based on an output of a computational model. The computational model is based on a state of charge of the rechargeable power source, a parameter related to outage of a power grid, and a QoS parameter relating to radio communication in the wireless communications network. The network node further applies, during a charging of the rechargeable power source, the operational parameter to the operation of the network node.

According to yet another aspect the object is achieved by providing a network node for charging a rechargeable power source in the network node. The network node is configured to obtain an operational parameter to an operation of the network node, wherein the operational parameter is based on an output of a computational model. The computational model is based on a state of charge of the rechargeable power source, a parameter related to outage of a power grid, and a QoS parameter relating to radio communication in a wireless communications network. The network node is further configured to apply, during a charging of the rechargeable power source, the operational parameter to the operation of the network node.

It is furthermore provided herein a computer program product comprising instructions, which, when executed on at least one processor, cause the at least one processor to carry out any of the methods above, as performed by the network node. It is additionally provided herein a computer-readable storage medium, having stored thereon a computer program product comprising instructions which, when executed on at least one processor, cause the at least one processor to carry out the method according to any of the methods above, as performed by the network node.

It is herein proposed a method that eliminates the above mentioned one or more disadvantages while still supporting fast charging of the batteries. According to embodiments herein it is provided a network node for enabling fast charging of the rechargeable power source, by utilizing a computational model to propose an operational parameter to apply, during the charging of the rechargeable power source, to the operation of the network node. Thus, enabling that the rechargeable power source is fully recharged before a next power outage occurs, and embodiments herein efficiently improve operations of the network node in the wireless communications network.

### BRIEF DESCRIPTION OF THE DRAWINGS

Embodiments will now be described in more detail in relation to the enclosed drawings, in which:

FIG. 1 is a schematic overview depicting a network node according to prior art;

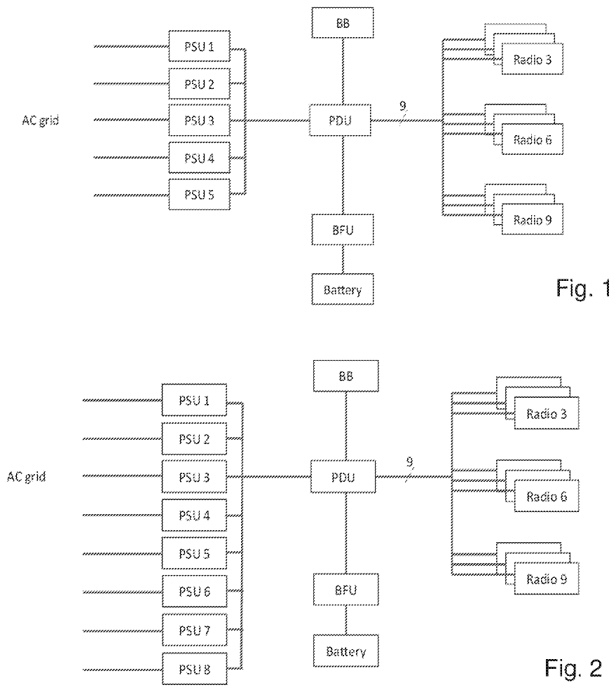

FIG. 2 is a schematic overview depicting a network node according to prior art;

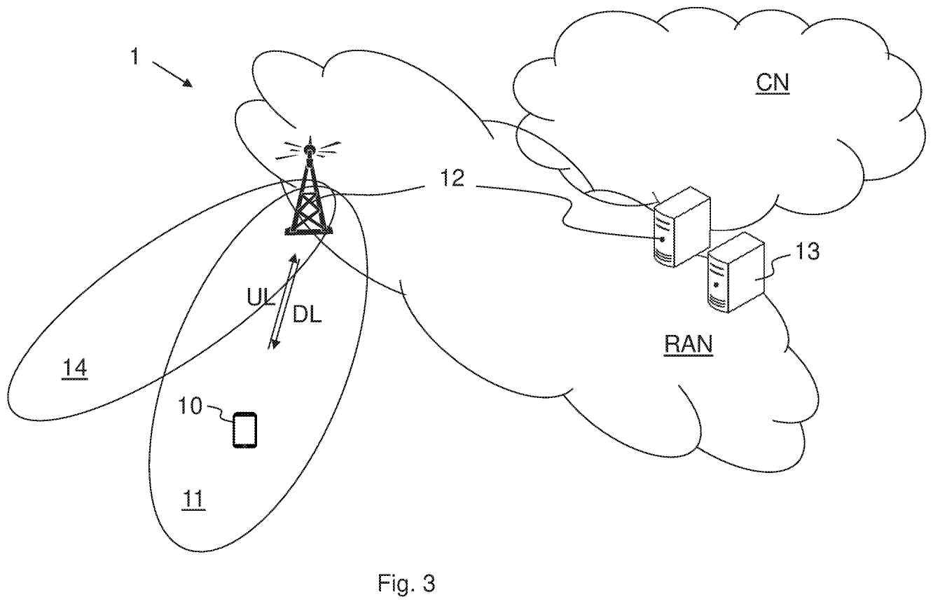

FIG. 3 is a schematic overview depicting a wireless communications network according to embodiments herein;

FIG. 4 is a schematic flowchart depicting a method performed by a network node according to embodiments herein;

FIG. 5 is a combined signalling scheme and flowchart according to embodiments herein;

FIG. 6 is a combined signalling scheme and flowchart according to embodiments herein;

FIG. 7 is a block diagram depicting a network node according to embodiments herein;

FIG. 8 is an overview depicting an algorithm according to embodiments herein;

FIG. 9 is a block diagram depicting a network node according to embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12-15 are flowcharts illustrating methods implemented in a communication system including a host computer, a base station and a user equipment.

### DETAILED DESCRIPTION

Embodiments herein may be described relating to a network node within the context of 3GPP NR radio technology (3GPP TS 38.300 V15.2.0 (2018 June)), e.g. using gNB as the radio network node. It is understood, that the problems and solutions described herein are equally applicable to wireless access networks and network nodes implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

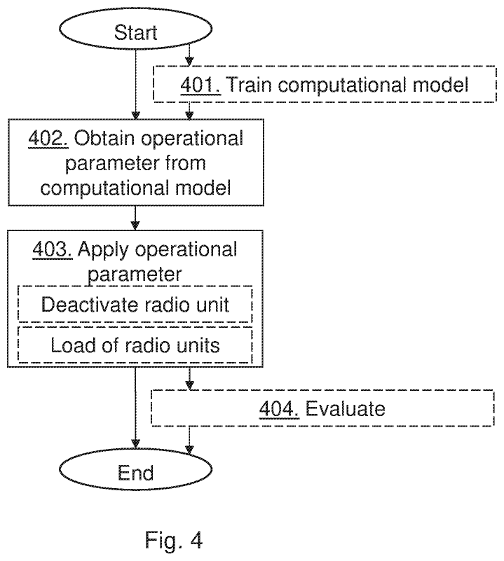

Embodiments herein relate to wireless communications networks in general. FIG. 3 is a schematic overview depicting a wireless communications network 1. The wireless communications network 1 comprises e.g. one or more RANs and one or more CNs. The wireless communications network 1 may use one or a number of different technologies, such as Wi-Fi, Long Term Evolution (LTE), LTE-Advanced, Fifth Generation (5G), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in 5G systems, however, embodiments are also applicable in further development of the existing communication systems such as e.g. a WCDMA and LTE.

In the wireless communications network 1, wireless devices e.g. a UE 10 such as a mobile station, a non-access point (non-AP) station (STA), a STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, Machine Type Communication (MTC) device, Device to Device (D2D) terminal, IoT operable device, or node e.g. smart phone, laptop, mobile phone, sensor, relay, mobile tablets or even a small base station capable of communicating using radio communication with a network node within an area served by the network node.

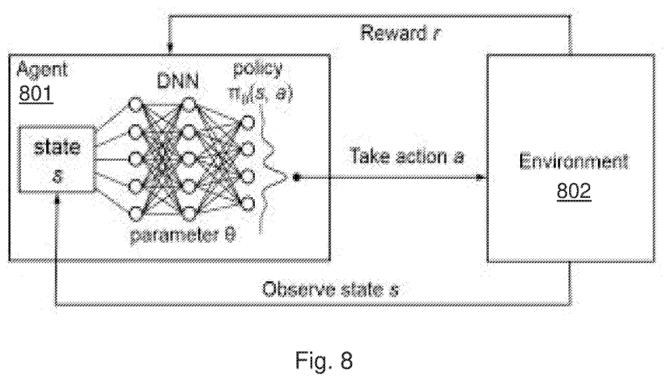

The wireless communications network 1 comprises a network node 12 providing e.g. radio coverage over a geographical area, e.g. one or more service areas 11, 14, of a radio access technology (RAT), such as NR, LTE, Wi-Fi, WiMAX or similar. The network node 12 may be a transmission and reception point, a computational server, a database, a server communicating with other servers, a server in a server park, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The network node 12 may alternatively or additionally be a controller node or a packet processing node such or similar. The network node 12 may be referred to as a serving network node wherein the service area 11 may be referred to as a serving cell or primary cell, and the serving network node communicates with the UE 10 in form of DL transmissions to the UE 10 and UL transmissions from the UE 10. The network node 12 may be a distributed node comprising a baseband (BB) unit and one or more remote radio units, see for example FIG. 7. The network node 12 may comprise at least one PSU and one or more rechargeable power sources, for example, an VRLA. It should be noted that a service area may be denoted as cell, beam, beam group or similar to define an area of radio coverage.

The wireless communications network 1 may further comprises another network node 13, for example for training and/or generating ML models in the wireless communications network 1 or similar.

When considering deployment of wireless communication technologies such as 5G to countries which have multiple power outages, a critical factor will be the power system and especially the charging aspect of the rechargeable power source. When adding a wireless communication technology on a very poor power grid, the rechargeable power source will not be able to be fully recharged or even partially recharged if no extra modifications are made, on the power system such as adding more PSU or other policy-based control for charging the rechargeable power sources. If the rechargeable power sources are not fully charge in an environment of multiple power outages during a day, the rechargeable power sources may be damaged in advance, which will impact the total cost of ownership (TCO) of the operator. As per previous, fast charging is of importance especially in very poor power grids, and needs to be considered as available feature, before deploying, for example, 5G radios.

A method is herein provided, for example, embedded in the BB unit of the network node 12, see for example FIG. 7, that enables fast charging of rechargeable power sources, when the power grid is available. For example, the network node 12 may reallocate and offload the radio traffic between the existing radio units on site during the charging of the rechargeable power source. As an example, reallocate radio traffic from one radio unit to another radio unit with a low physical resource block (PRB) utilization. By offloading to the other radio unit resulting in an increase of the utilization of one specific radio allowing to turn OFF the one radio unit. Embodiments herein may offload one or more radio units and still maintaining same or an acceptable Quality of Service (QoS) in the wireless communications network 1. When the method is active the BB, see for example FIG. 7, the network node 12 may check all radio utilizations of the radio units and may offload one or more radio units, to increase utilization of other radio units, for example, increase utilization of some radio units that are not fully utilized, typically 20-30%, and allowing to turn off some other radio units.

By turning off one or more radio units, at the moment of recharging, an increase of available incoming power is delivered to the rechargeable power sources. Thus, enabling a faster recharging at the return of the power grid after a power outage, thus the PSUs are powered by the fully charged rechargeable batteries during an upcoming power outage. It is herein proposed using a computational model method to predict and estimate a recharging time of the rechargeable power source and propose actions to turn off radios or offload radios, based on the estimated recharging time.

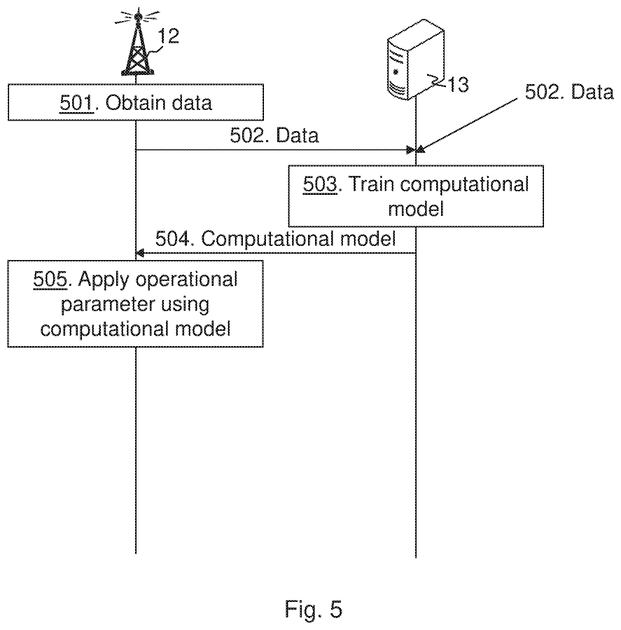

The method actions performed by the network node 12 for charging a rechargeable power source, e.g. handling operation during the charging of the rechargeable power source, in a wireless communications network according to embodiments will now be described with reference to a flowchart depicted in FIG. 4. The actions do not have to be taken in the order stated below, but may be taken in any suitable order. Actions performed in some embodiments are marked with dashed boxes. As stated above the network node 12 comprises at least one power supply unit, and one or more rechargeable power sources for supplying power to the network node 12 e.g. suppling power to radio units connected to the network node 12 during power outages of the power grid. The one or more rechargeable power sources may comprise one or more energy storages, and/or batteries. It should be noted that the network node may be a distributed radio network node comprising at least one remote radio unit and one baseband unit co-located with the at least one power supply unit, and the one or more rechargeable power sources. The network node 12 may be a base station, an access node, a server, or a communication node.

Action 401. The network node 12 may train the computational model by rewarding the computational model when the rechargeable power source is fully charged and when a set QoS in the wireless communications network 1 is maintained before an outage of the power grid. For example, maintaining a quality of service for a set of QoS metrics during the charging of the rechargeable power source until it is fully charged.

Action 402. The network node 12 obtains the operational parameter to an operation of the network node 12, wherein the operational parameter is based on an output of the computational model. The computational model is based on a state of charge of the rechargeable power source, a parameter related to outage of a power grid, and a QoS parameter relating to radio communication in the wireless communications network 1. The network node 12 may obtain the operational parameter by receiving the output from the computational model executed internally or from another network node. The computational model may thus be executed by the network node 12 to obtain the operational parameter. The state of charge may indicate a percentage or a level of a fully charged rechargeable power source, and the parameter related to outage of the power grid may comprise one or more parameters indicating number of outages per day and/or duration of one or more of the outages. The QoS parameter relating to communication in the wireless communications network may be signal to interference plus noise ratio (SINR), signal to noise ratio (SIR), reference signal received power (RSRP), and/or reference signal received quality (RSRQ). The QoS parameter may be associated with a radio access technology used. The computational model may further be based on, in addition to the state of charge of the rechargeable power source, the parameter related to outage of a power grid, and the QoS parameter, a type of rechargeable power source, an environmental parameter, criticality of network slice, and a state of health of the rechargeable power source. Criticality of network slice may be defined by slice service type (SST). SST define expected behaviour of a Network Slice in terms of specific features and services. Standardized SST values include enhanced Mobile Broadband (eMBB), Ultra Reliable Low Latency Communications (URLLC) and Massive Internet of Things (MIoT). The computational model may be a reinforcement learning model, a machine learning (ML) model, and/or a deep neural network function. For example, the computational model may be a machine learning model trained by means of deep reinforcement learning. The fast charging may be dependent on the outage duration or future outage duration and the relation to the radio load at the time of use.

Action 403. The network node 12 applies, during a charging of the rechargeable power source, the operational parameter to the operation of the network node 12. The operational parameter may be related to balancing load between radio units of one or more radio access technologies, and/or to deactivation of one or more radio units to achieve faster charging of the rechargeable power source. For example, the operational parameter may comprise maximum number of UEs served by different radio units, turning off a radio unit, and/or increase/decrease number of served UEs of a radio unit supporting a certain RAT. For example, during the deployment of 5G radio units, many operators keep the amount of radio units active of, for example, same RATs on-site, without removing any legacy radio access technologies upon charging of the rechargeable power source. Thus, the operators do not consider that the different RATs can handle and combine different services. However, embodiments herein may take the RAT of the radio units into consideration keeping a radio unit for LTE active and deactivating a radio unit of NR during the charging of the rechargeable power source.

Action 404. The network node 12 may then evaluate application of the operational parameter based on whether the application of the operational parameter fulfills a condition or not. For example, the condition may be fulfilled, when the operational parameter is applied to the operation of the network node, and the rechargeable power source is fully charged within a time interval and a level of QoS in the wireless communications network is upheld within the time interval. The time interval may be defined by a time when an outage of the power grid, present or future power outage, occurs. For example, the time interval may the time interval between power outages so that the rechargeable power source is fully powered and still the level of QoS is maintained between the power outages. The network node 12 may apply the fast-recharging method only during recharging period of the rechargeable power source and may then return back to normal operation.

It should be noted that the network node 12 may provide data, internally or externally, of the network node 12 to train the computational model. The data may comprise an indication of one or more power outages, one or more set voltages, and an indication of usage of the one or more rechargeable power sources upon the one or more set voltages. The computational model may be trained at the network node 12 or at the other network node 13.

Thus, according to embodiments herein the method may control the radio traffic, based on battery state of charge (SOC) and PSU outage cycles. Specifically, the method may introduce control of radio traffic offloading, and ability to turn radio ON/OFF based on the previous power outage cycle and the battery state of charge. The needed battery SOC, will propose how the offloading shall be made in relation to time of charge, until next power outage occurs. The new function is active during battery recharging, when power grid has return and until battery is fully charged. Furthermore, the computational model to determine the operational parameter may be a ML model, and specifically a reinforcement learning (RL) method, that rewards different control actions, in relation to the power outages duration, connected to a certain SOC time of the battery and propose offloading of radio traffic or radio turn ON/OFF, if several radio on site, but still maintaining a certain QoS in the wireless communications network. The ML model may propose the best suitable offloading for fast charging of batteries, in order for these batteries to be fully charged before next power outage cycle occurs. It should be noted that the ML model may take into account that multiple power outages can occur per day, e.g., 5-10, and may also include the daily radio traffic variation in time.

In an ML method proposed, a Deep Q-Learning approach is used wherein a neural network, Deep Q-Network or deep neural network (DNN), is trained to predict the next control action, i.e. the operational parameter, that yields the better results (the best suitable offloading for battery fast charge but still maintaining QoS). The ML model may be trained, to predict the different recharge times for respective SOC, and propose action as 1) offloading of radio traffic to other radio on site, based on here utilization. Offloading is the try to maximize one radio unit with traffic 2) radio turn ON/OFF 3) or several combined actions as multiple offloading, or multiple radio turn ON/OFF without sacrificing the QoS.

It should be noted that the radio control turn ON/OFF can be adjusted based on the RATs criticality, as GSM, WCDMA, LTE or NR.

In yet another embodiment and in case of 5G networks, it is also possible to adjust radio control ON/OFF based on the criticality of the network slices served by this radio. For example, if there are only best effort network slices, e.g., enhanced mobile broadband (eMBB), then radio can be turned off. On the other hand, if the network slices are mission critical, for example, of type ultra-reliable low latency communication (uRLLC), then the radio cannot be turned off for that period of time the slice is activated.

In another embodiment, the fast recharging method is only active, during recharging period of the batteries, and returns back to normal operation based on BB “ordinary” control as it was in the configuration before the outage occurred.

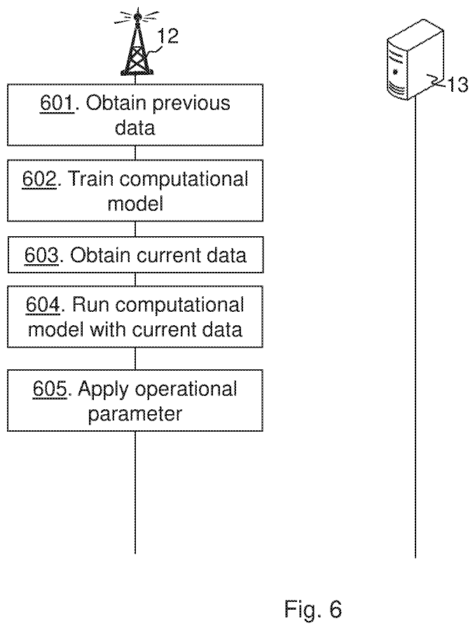

FIG. 5 is a schematic combined signalling scheme and flowchart depicting embodiments herein.

Action 501. The network node 12 or any network node may collect, e.g. obtain, data denoted as previous data to be fed to the computational model. Previous data may comprise operational status of power feed to one or more PSUs, number and duration of power outages, QoS in the wireless communications network such as SINR, SIR, RSRQ, RSRP or similar, and/or time for fully charging the one or more rechargeable power sources.

Action 502. The network node 12 may then transmit the collected previous data to another network node or a server training the computational model.

Action 503. The other network node 13 may then train the computational model using the collected previous data. The computational model may be trained by rewarding the computational model when the rechargeable power source is fully charged before an outage of the power grid and when a set QoS in the wireless communications network is maintained during the recharging of the rechargeable power source.

Action 504. The other network node 13 may then transmit the trained computational model or parts of it to the network node 12

Action 505. The network node 12 then applies the operational parameter such as change traffic load between radio units from the output of the computational model. The network node 12 may, for example, execute or run the computational model using current data as input into the computational model. From the computational model an output is generated and indicating the operational parameter.

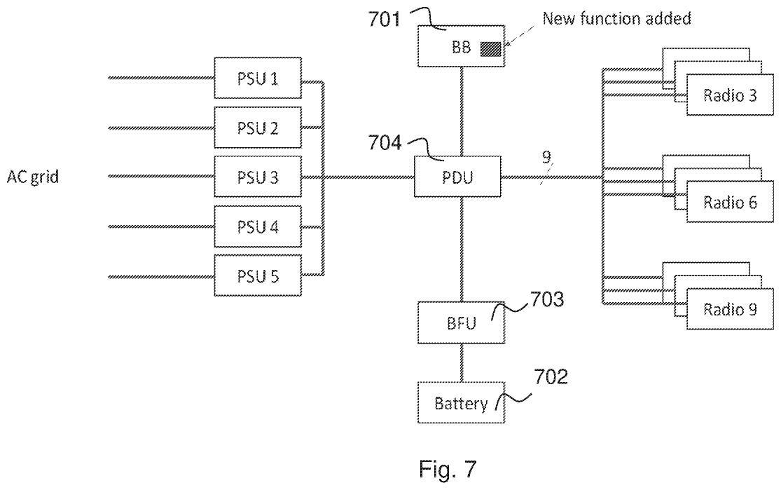

FIG. 6 is a schematic overview depicting an example of embodiments herein.

Action 601. The network node 12 may collect, e.g. obtain, data denoted as previous data to be fed to the computational model. Previous data may comprise: operational status of power feed to one or more PSUs; number and duration of power outages; QoS in the wireless communications network such as SINR, SIR, RSRQ, RSRP or similar; and/or time for fully charging the one or more rechargeable power sources.

Action 602. The network node 12 may then train the computational model using the collected previous data. The computational model may be trained by rewarding the computational model when the rechargeable power source is fully charged before an outage of the power grid and when a set QoS in the wireless communications network is maintained during the recharging of the rechargeable power source.

Action 603. The network node 12 may further collect present or current data indicating a certain operational state. E.g. the present data may comprise: operational status of power feed to one or more PSUs; number and duration of power outages; QoS in the wireless communications network such as SINR, SIR, RSRQ, RSRP or similar; and/or time for fully charging the one or more rechargeable power sources.

Action 604. The network node 12 may then execute the computational model using received collected data as input into the computational model. From the computational model an output is generated. E.g. the output may indicate operational parameter such as maximum number of UEs served by different radio units, turning off a radio unit, and/or increase/decrease number of served UEs of a radio unit supporting a certain RAT.

Action 605. The network node 12 may then, based on the output, apply the operational parameter to the operation of the network node 12. For example, move traffic load to one or more radio units from one or more radio units, and/or disconnect a radio unit during the charging of the rechargeable power source.

FIG. 7 shows a block diagram depicting an arrangement of the network node 12 connected via cabling to remote radio units (radios 1-9). The network node 12 may comprise a BB unit 701, a number of PSUs (PSU 1-5) and the rechargeable power source, for example, a battery 702, connected via a BFU 703 to a PDU 704. The computational model such as a ML model provides output indicating the operational parameter of the network node 12 during charging of the rechargeable power source after a power outage of the power grid. The function is incorporated into the BB unit wherein the network node 12 obtains the operational parameter to the operation of the network node, wherein the operational parameter is based on the output of the computational model. The computational model is based on the state of charge of the rechargeable power source, the parameter related to outage of the power grid, and the QoS parameter relating to radio communication in the wireless communications network. The network node 12 then applies, during the charging of the rechargeable power source, the operational parameter to the operation of the network node 12.

In the geographical regions where the power outages are frequent and usually follow a seasonal pattern, it is simpler to predict the power outage well in advance. However, in the regions where the power outages are very rare, training on a much longer timescale is required to capture patterns of readings from PSUs just before the power outage or in the events when the rechargeable power source is used. Additionally, the observations from cells in the region (town or locality) and contextual information can be used as input to determine the operational parameter.

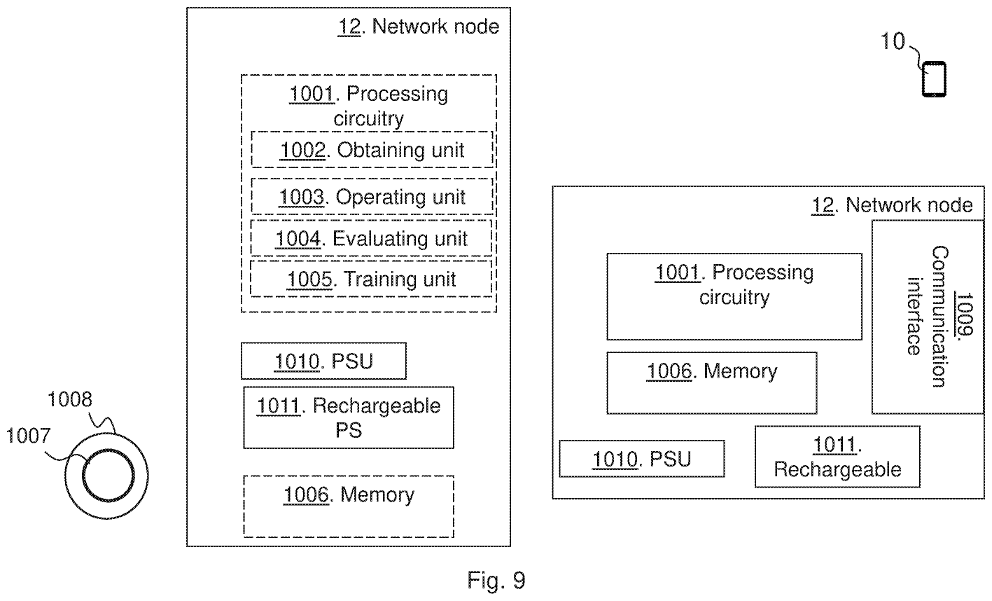

The sequence diagram in FIG. 8 incorporates all the active participant parts that depicts a training process of the ML component. In FIG. 8 the computational model is illustrated as a reinforcement learning (RL) loop, for example a DNN such as a Deep Q-Learning approach.

In the RL model, given a state of the environment, an agent 801 takes an action, a, against an environment 802. Based on the outcome of the action, the environment will reward the agent as well as change the state to a new state. Below are the definitions of agent, action ‘a’, state ‘s’, environment, reward ‘r’ that may be used in the computational model according to some embodiments herein.
Agent 801 may be software (SW) running in the BB unit of the network node 12, see FIG. 7, that is responsible for achieving the fastest possible battery charge without compromising QoS.
Action ‘a’ may be a state space of options available to the agent 801, in order to increase battery charging speed. For example, to optimize state of recharge time (SORT), while maintaining QoS for existing UE in the wireless communications network, for example, using a policy defined as a function of state and action, π₀(s,a). This state space may comprise one or more of the following actions, which are examples of the operational parameter i.e. action a:
   An action to turn the radio ON or OFF
   An action to offload a radio by using another underutilized radio in the same RBS
   A combination of the above.
   Note that it is possible that one action consists of several options exercised simultaneously or sequentially in one “episode” (episode in RL is a sequence of states, actions and rewards). For example, in the same sector, first action is to offload radio traffic, to other underutilized radio, to try to maximize one radio, up to 80%-90% utilization, and later on Turn OFF the other radio unit (by doing so power saving is made on the other radio units)
Observed states s may be a set of parameters θ produced by the environment 802 as response to an action, i.e. the operational parameter, and used for input to the DNN to calculate the next action. These parameters θ may be:
   1) Power outage duration [get V from performance monitoring (PM) PSU]
   2) SOC [get SOC from PM battery]
   3) Radio traffic [get traffic load from PM cell]
   4) QoS [get QoS from PM cell]
Environment 802 may be defined as the monitoring infrastructure of the network node 12 (contained e.g. in the baseband), which given an action monitors the QoS and battery SOC, calculates a reward r and provides this information back to the agent 801 as a reward r.
Reward r may be defined as a normalized 0 to 1 value generated by the environment that indicates the effectiveness of the action. The reward r may be calculated as follows:

r=(c·SOC)+((1−c)·QoS)
c is a constant that indicates how biased the reward towards fast battery recharge time is in expense of quality of service. If good quality of service is of same importance as to fast battery recharge time, then c is 0.5 (50%).
   SOC is a 0 to 1 value indicating how fast the battery charged. If the value is closer to 1, then that means the battery is fully charged and it charged fast—vice versa for values closer to 0, were

SOC=Remaining capacity (Ah)/Nominal capacity (Ah)×100
Note: normal capacity is the initial capacity of the battery which is known from start
   QoS is a 0 to 1 value indicating the quality of service for the cell after the action(s) of the agent took place. In order to measure QoS key performance indicators (KPI) for RAN monitoring as described in [1] may be used. KPIs may comprise parameters relating to one or more of the following: accessibility, retainability, integrity, availability and/or mobility. QoS is a weighted average of those KPIs:

For 2G networks:

QoS_{2G}=((c_{availability}*network_availability)+(c_{accessibilty}*service_accessibility)+(c_{retainability}*service_retainability))/3

For 3G and 4G and 5G networks:

QoS_{5G}=QoS_{4G}=QoS_{3G}=((c_{availability}*network_availability)+(c_{accessibilty}*service_accessibility)+(c_{retainability}*service_retainability)+(c_{integrity}*service_integrity)/4

. . . where:
network_availability is an indication of the uptime of the network. At the very least a cell availability (0 to 1) KPI can be used, and in case of 4G and 5G a sum of cell availability and data service availability divided by 2 can be used. Cell availability and data service availability already exist in BB in the form of performance monitoring (PM) counters.
service_accessibilty indicates how reliable is the service. In 2G it is a weighted average of traffic channel (TCH) congestion rate, Standalone Dedicated Control Channel (SDCCH) congestion rate, CALL success rate and call setup success rate. In 3G it is also a weighted average of voice block call rate, voice call setup success rate, voice call success rate and data access success rate. Finally in 4G and 5G it is provided directly by KPI data service access success rate.
service_retainability indicates the performance trend for QoS (in other words the rate of increase or decrease of one or more KPI). In 2G it is given by call completion rate KPI, in 3G from voice call completion rate and (1−data drop rate). In 4G and 5G from (1−data service drop rate).
service_integrity indicates an average throughput for the cell and is given by the aggregate of download throughput divided by a reference throughput that is supported by the cell, and upload throughput divided by reference throughput.
all coefficients beginning with C are introduced for bias—and work as described in the reward function calculation above. All coefficients range between 0 and 1 and the following rule applies:
   c_{availability}+c_{accessibilty}+c_{retainability}+c_{integrity}=1

It should herein be noted that the duration of an episode may take a long time (e.g. hours or days even), so that the environment has enough time to generate an accurate reward. It is also possible to use multiple QoS for different RATs in order to deduct a final QoS, in case the RBS has more than one RATs. For example, if LTE and 3G are supported, then

QoS=(QoS_{3G}+QoS_{4G})/2

Again, the above equation may have coefficients, in case QoS for one radio access technology more may be taken into account in expense of the other.

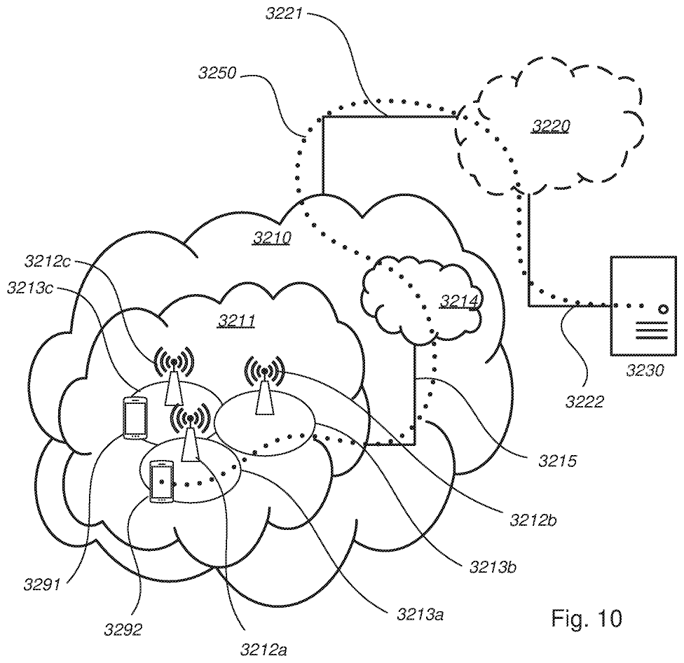

FIG. 9 is a block diagram depicting the network node 12 for charging the rechargeable power source in the network node 12. The network node 12 may comprise at least one power supply unit 1010, and one or more rechargeable power sources 1011 for supplying power to the network node 12 according to embodiments herein. The network node 12 may be arranged to communicate with one or more UEs such as the UE 10.

The network node 12 may comprise processing circuitry 1001, e.g. one or more processors, configured to perform the methods herein.

The network node 12 may comprise an obtaining unit 1002, e.g. a receiver or a transceiver. The network node 12, the processing circuitry 1001 and/or the obtaining unit 1002 is configured to obtain the operational parameter to the operation of the network node 12, wherein the operational parameter is based on the output of the computational model. The computational model is based on the state of charge of the rechargeable power source, the parameter related to outage of the power grid, and the QoS parameter relating to radio communication in the wireless communications network. Thus, may obtain the output from the computational model. The computational model may further be based on the type of rechargeable power source, the environmental parameter, the criticality of network slice, and the state of health (SOH) of the rechargeable power source. The state of charge may indicate the percentage or the level of a fully charged rechargeable power source. The parameter related to outage of the power grid may comprise one or more parameters indicating number of outages per day and/or duration of one or more of the outages. The QoS parameter relating to communication in the wireless communications network may be associated with a radio access technology used. The operational parameter may be related to balancing load between radio units of one or more radio access technologies, and/or to deactivation of one or more radio units to achieve faster charging of the rechargeable power source.

The network node 12 may comprise an operating unit 1003. The network node 12, the processing circuitry 1001 and/or the operating unit 1003 is configured to apply, during the charging of the rechargeable power source, the operational parameter to the operation of the network node 12.

The network node 12 may comprise an evaluating unit 1004. The network node 12, the processing circuitry 1001 and/or the evaluating unit 1004 may be configured to evaluate the application of the operational parameter based on whether the application of the operational parameter fulfills the condition or not. The condition may be considered fulfilled when the operational parameter is applied to the operation of the network node, and the rechargeable power source is fully charged within the time interval, and the level of QoS in the wireless communications network is upheld within the time interval, wherein the time interval is defined by the time when an outage, present or future, of the power grid occurs.

The network node 12 may comprise a training unit 1005. The network node 12, the processing circuitry 1001 and/or the training unit 1005 may be configured to train the computational model by rewarding the computational model when the rechargeable power source is fully charged before an outage of the power grid and when a set QoS in the wireless communications network is maintained.

The network node 12 may be a distributed radio network node comprising at least one remote radio unit and one baseband unit co-located with the at least one power supply unit 1010, and the one or more additional rechargeable power sources 1011.

The computational model may be a machine learning model such as a neural network, a reinforcement learning model, a deep neural network function, or a computational tree model. For example, the computational model may be a machine learning model trained by means of deep reinforcement learning.

The network node 12 may be a base station, an access node, a server, or a communication node.

The network node 12 further comprises a memory 1006. The memory comprises one or more units to be used to store data on, such as output voltages, power outages, operational data, SOC of rechargeable power source, operational parameters, applications to perform the methods disclosed herein when being executed, and similar. The network node 12 comprises a communication interface 1009 comprising e.g. one or more antennas.

The methods according to the embodiments described herein for the network node 12 are respectively implemented by means of e.g. a computer program product 1007 or a computer program, comprising instructions, i.e., software code portions, which, when executed on at least one processor, cause the at least one processor to carry out the actions described herein, as performed by the network node 12. The computer program product 1007 may be stored on a computer-readable storage medium 1008, e.g. a universal serial bus (USB) stick, a disc or similar. The computer-readable storage medium 1008, having stored thereon the computer program product, may comprise the instructions which, when executed on at least one processor, cause the at least one processor to carry out the actions described herein, as performed by the network node 12. In some embodiments, the computer-readable storage medium may be a non-transitory or a transitory computer-readable storage medium. Thus, it is herein disclosed a network node for charging the rechargeable power source in the network node, wherein the radio network node comprises processor circuitry and a memory for storing instructions executable by said processor circuitry, and whereby the processing circuitry is operative to perform a method according to any of the embodiments above as performed by the network node.

In some embodiments a more general term “network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or UE is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However, the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

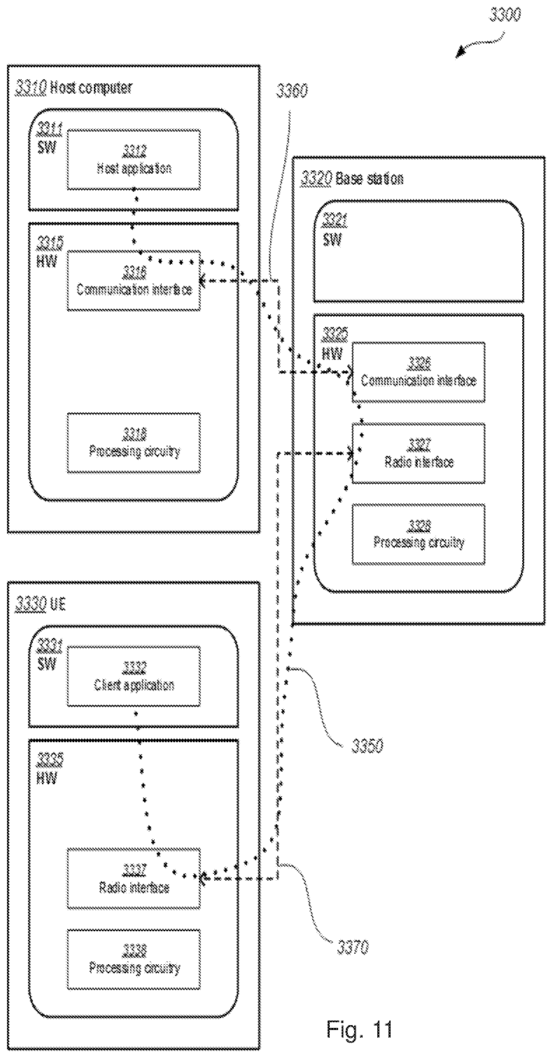

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

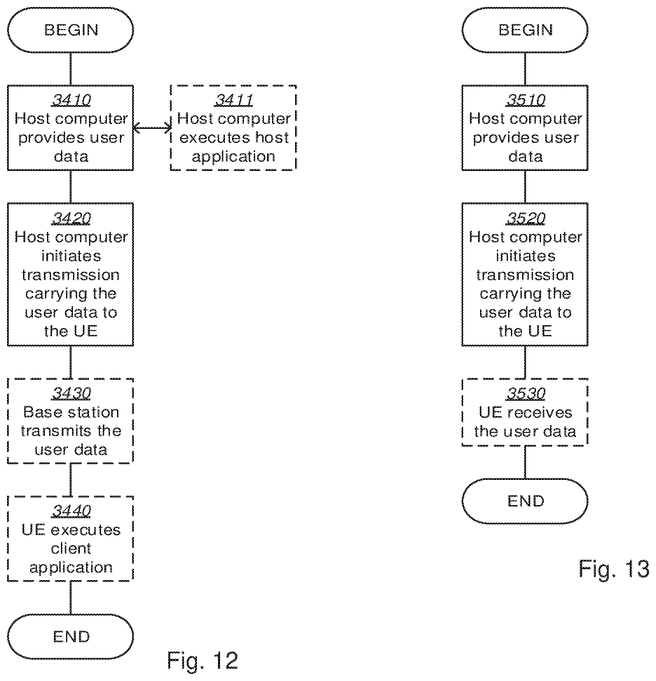

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the operation of the network node to enhance performance of the network node and thereby provide benefits such as improved battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

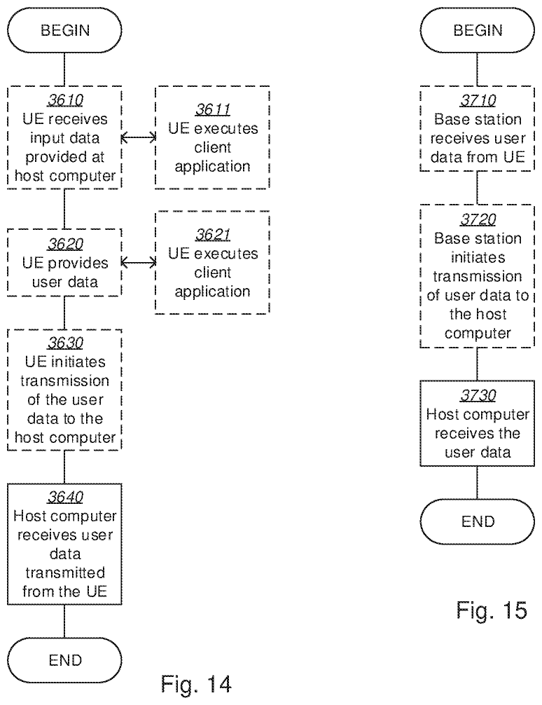

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### References

[1] 3rd Generation Partnership Project TS 32.450 v16.0.0; Technical Specification Group Services and System Aspects; Telecommunication management; Key Performance Indicators (KPI) for Evolved Universal Terrestrial Radio Access Network (E-UTRAN); Requirements (Release 16)

### Abbreviations

AC Alternating Current
ASIC application-specific integrated circuit
Ah Ampere Hour
AP STA Access Point Station
BB Base Band
BFU Battery Fuse Unit
BS Base Station
BSC base station controller
BTS base transceiver station
CDMA Code Division Multiple Access
CN Core Network
GSM Global System for Mobile Communications
DAS Distributed Antenna System
DL Down Link
DNN Deep neural network
DSP digital signal processor
DQN Deep Q-Learning
E-SMLC Evolved Serving Mobile Location Centre
FDD Frequency Division Duplex
HSPA High-Speed Packet Access
HW Hardware
DG Diesel Generator
D2D device-to-device
KPI Key Performance Indicator
LTE Long Term Evolution
LME Laptop Mounted Equipment
MCG Master cell group
MDT Minimizing Drive Test
MME Mobile Management Entity
ML Machine Learning
MSR Multi-Standard Radio
MSC Mobility Switching Centre
M2M Machine to Machine
NR New Radio
OPEX Operating Expenditure
OTT Over The Top
PDU Power Distribution Unit
PM Performance monitor
PSU Power Supply Unit
RAN Radio Access Network
RAM Random-Access Memory
RAT Radio Access Technology
RBS Radio Base Station
RL Reinforced Learning
RNC Radio Network Controller
RRU Remote Radio Unit
RSPR Reference Signal Received Power
RSRQ Reference Signal Received Quality
ROM Read-Only Memory
SDCCH Standalone Dedicated Control Channel
SCG Secondary Cell Group
SINR Signal To Noise Ratio
SIR Signal To Ratio
SOC State of Charge
SOH State of Health
SON Self-Organizing Network
SORT State of Recharge Time
STA Station
SW Soft Ware
TCH Traffic Channel
TCO Total Cost of Ownership
TDD Time Division Duplex
MB Ultra Mobile Broadband
UMTS Universal Mobile Telecommunications System
UL Up Link
UTRAN UMTS terrestrial radio access network
uRLLC Ultra-Reliable Low Latency Communication
ProSe UE Proximity Capable UE
OSS Operation Support System
QoS Quality of Service
O&M Operation and Maintenance
USB Universal Serial Bus
VRLA Valve Regulated Lead Acid
WCDMA wideband code division multiple access
WiMAX Worldwide Interoperability for Microwave Access
WLAN Wireless Local Area Network
3GPP Third Generation Partnership Project

1. A method performed by a network node, in a wireless communications network, for charging a rechargeable power source in the network node, the method comprising
obtaining an operational parameter to an operation of the network node, wherein the operational parameter is based on an output of a computational model, and wherein the computational model is based on a state of charge of the rechargeable power source, a parameter related to outage of a power grid, and a quality of service, QoS, parameter relating to radio communication in the wireless communications network; and
applying, during a charging of the rechargeable power source, the operational parameter to the operation of the network node.

2. The method according to claim 1, further comprising
evaluating application of the operational parameter based on whether the application of the operational parameter fulfills a condition or not.

3. The method according to claim 2, wherein the condition is fulfilled, when the operational parameter is applied to the operation of the network node, the rechargeable power source is fully charged within a time interval and a level of QoS in the wireless communications network is upheld within the time interval, wherein the time interval is defined by a time when an outage of the power grid occurs.

4. The method according to claim 1, wherein the computational model is further based on a type of rechargeable power source, an environmental parameter, criticality of network slice, and/or a state of health of the rechargeable power source.

5. The method according to claim 1, wherein the state of charge indicates a percentage or a level of a fully charged rechargeable power source.

6. The method according to claim 1, wherein the parameter related to outage of the power grid comprises one or more parameters indicating number of outages per day and/or duration of one or more of the outages.

7. The method according to claim 1, wherein the operational parameter is related to balancing load between radio units of one or more radio access technologies, and/or to deactivation of one or more radio units to achieve faster charging of the rechargeable power source.

8. The method according to claim 1, wherein the QoS parameter relating to communication in the wireless communications network is associated with a radio access technology used.

9. The method according to claim 1, further comprising
training the computational model by rewarding the computational model when the rechargeable power source is fully charged before an outage of the power grid and when a set QoS in the wireless communications network is maintained.

10. The method according to claim 1, wherein the computational model is a reinforcement learning model, a machine learning model, and/or a deep neural network function.

11.-12. (canceled)

13. A network node for charging a rechargeable power source in the network node, wherein the network node is configured to
obtain an operational parameter to an operation of the network node, wherein the operational parameter is based on an output of a computational model, and wherein the computational model is based on a state of charge of the rechargeable power source, a parameter related to outage of a power grid, and a quality of service, QoS, parameter relating to radio communication in a wireless communications network; and
apply, during a charging of the rechargeable power source, the operational parameter to the operation of the network node.

14. The network node according to claim 13, wherein the network node is further configured to
evaluate application of the operational parameter based on whether the application of the operational parameter fulfills a condition or not.

15. The network node according to claim 14, wherein the condition is fulfilled, when the operational parameter is applied to the operation of the network node, the rechargeable power source is fully charged within a time interval and a level of QoS in the wireless communications network is upheld within the time interval, wherein the time interval is defined by a time when an outage of the power grid occurs.

16. The network node according to claim 13, wherein the computational model is further based on a type of rechargeable power source, an environmental parameter, criticality of network slice, and/or a state of health of the rechargeable power source.

17. The network node according to claim 13, wherein the state of charge indicates a percentage or a level of a fully charged rechargeable power source.

18. The network node according to claim 13, wherein the parameter related to outage of the power grid comprises one or more parameters indicating number of outages per day and/or duration of one or more of the outages.

19. The network node according to claim 13, wherein the operational parameter is related to balancing load between radio units of one or more radio access technologies, and/or to deactivation of one or more radio units to achieve faster charging of the rechargeable power source.

20. The network node according to claim 13, wherein the QoS parameter relating to communication in the wireless communications network is associated with a radio access technology used.

21. The network node according to claim 13, wherein the network node is configured to
train the computational model by rewarding the computational model when the rechargeable power source is fully charged before an outage of the power grid and when a set QoS in the wireless communications network is maintained.

22. The network node according to claim 13, wherein the computational model is a reinforcement learning model, a machine learning model, and/or a deep neural network function.
